(19) United States
(12) Patent Application Publication
(10) Pub. No.: US 2025/0245084 A1
(43) Pub. Date: Jul. 31, 2025

(54) MEDIA PLATFORM WITH GENERATIVE ARTIFICAL INTELLIGENCE FOR SOLVING DIAGNOSTIC ISSUES

(71) Applicant: Google LLC, Mountain View, CA (US)

(72) Inventors: Ajay Karthik Nama Nagaraj, Bangalore (IN); Shiva Bhalla, Lucknow (IN); Netri, South West Delhi (IN); Veenu Mishra, Delhi (IN); Shatakshi Gupta, Mathura (IN); Parantap Sharma, Jaipur (IN); Kanishka Mishra, Bangalore (IN)

(21) Appl. No.: 18/425,690

(22) Filed: Jan. 29, 2024

(51) Int. Cl. G06F 11/07; G06F 40/40

(52) U.S. Cl. CPC G06F 11/0736; G06F 40/40

(57) ABSTRACT

A device may receive, via a user interface of a media application, information (e.g., a natural language query, image data, and/or video data) about a technical issue of a television device. A device may generate a prompt with a request to identify a technical solution for solving the technical issue. A device may receive, from a large language model, a prompt response with information (e.g., text, image, and/or video data) about the technical solution. A device may display the technical solution on the user interface of the media application.

### BACKGROUND

A user may encounter one or more technical issues with the operation of a television device. In some examples, a user may perform a web search to identify a solution to a particular problem. In some examples, the user may call the manufacturer or a service provider representation to receive troubleshooting advice and information for solving the problem.

### SUMMARY

In some aspects, the techniques described herein relate to a method including: receiving, via a user interface of a media application, information about a technical issue of a television device; generating a prompt with a request to identify a technical solution for solving the technical issue; receiving, from a large language model, a prompt response with information about the technical solution, the large language model being calibrated based on at least one of television user manuals, television call center recording, television source code, or online discussion forums; and displaying the technical solution on the user interface of the media application.

In some aspects, the techniques described herein relate to a television device including: at least one processor; and a non-transitory computer-readable medium storing executable instructions that cause the at least one processor to: receive, via a user interface of a media application, a natural language query about a technical issue of a television device; generate a prompt with a request to identify a technical solution for solving the technical issue; receive, from a large language model, a prompt response with information about the technical solution, the large language model being calibrated based on at least one of television user manuals, television call center recording, television source code, or online discussion forums; and display the technical solution on the user interface of the media application.

In some aspects, the techniques described herein relate to a non-transitory computer-readable medium storing executable instructions that when executed by at least one processor cause the at least one processor to execute operations, the operations including: receiving, via a user interface of a media application, information about a technical issue of a television device; generating a prompt with a request to identify a technical solution for solving the technical issue; receiving, from a large language model, a prompt response with information about the technical solution, the large language model being calibrated based on at least one of television user manuals, television call center recording, television source code, or online discussion forums; and displaying the technical solution on the user interface of the media application.

The details of one or more implementations are set forth in the accompanying drawings and the description below. Other features will be apparent from the description and drawings, and from the claims.

### BRIEF DESCRIPTION OF THE DRAWINGS

FIG. 1A illustrates a system that uses a machine-learning model to identify a technical solution about a technical issue according to an aspect.

FIG. 1B illustrates a prompt response with multiple technical solutions according to an aspect.

FIG. 1C illustrates examples of training data used to train the machine-learning model according to an aspect.

FIG. 2 is a flowchart depicting example operations of identifying technical solutions using a machine-learning model according to an aspect.

### DETAILED DESCRIPTION

This disclosure relates to a system configured to calibrate (e.g., fine-tune, adjust) a pre-trained large language model (LLM) (e.g., a text-to-text model) using television training data such as television user manuals, television source code and bug reports, television call center recordings, and/or online discussion forums. The system provides a user interface on a television device that enables the user to submit information about a technical issue of the television device. In some examples, the information about the technical issue includes a natural language query. In some examples, the information about the technical issue includes an image (e.g., a screenshot) of an interface of the television. In some examples, the information includes a video that includes at least a portion of the television device. In some examples, the system includes a speech-to-text module configured to convert the user's speech to text and use the text as the natural language query. In some examples, the user may enter a textual description via an input field on the user interface. In response to the natural language query, the system may generate a prompt with a request for one or more technical solutions to solve the technical issue as described in the natural language query. In some examples, the system may obtain information about the television device (e.g., operating system version, make and model of television device, specification details about the television device, etc.), and include the information about the television device in the prompt. The LLM may determine which technical solutions can be used to solve the technical issue(s) and generate a prompt response with information about the technical solution(s). In some examples, a technical solution may include one or more tasks (or a sequence of tasks), which, when performed, may solve the technical issues.

In some examples, the system may display the technical solution(s) on the user interface of the media application, and each technical solution may include one or more tasks. In some examples, the user may use the television device to execute the task(s) of a particular technical solution to solve the technical issue. In some examples, the television device includes a task executor configured to execute the task(s) of the technical solution (without user involvement) to solve the technical issue. For example, instead of the user performing the tasks using the television device, the television device itself programmatically performs the technical solution by executing the task(s). In some examples, the task executor may transmit a code request (e.g., a second prompt) to the LLM to obtain executable instructions. The LLM may generate a prompt response with executable instructions, and the system may provide the executable instructions to the television device. The executable instructions, when executed by the television device, cause the television device to execute the tasks of the technical solution. In some examples, the user interface of the media application includes one or more UI elements that enable the user an option for the user to perform the task(s) or the television device to perform the task(s). In some examples, instead of submitting a natural language query about a technical issue, the system may programmatically detect a technical issue, communicate with the LLM to identify a technical solution, and initiate the task executor to programmatically execute the tasks of the technical solution without involvement of the user.

The system may determine whether or not the technical solution was successful in solving the technical issue. In some examples, the user may provide feedback via the user interface that indicates whether or not the technical solution was successful in solving the technical issue. In some examples, the system may programmatically determine (without user prompting) whether the technical solution was successful. If the technical solution was not successful, the system may identify another technical solution (e.g., from the prompt response previously received), and display the alternative technical solution on the user interface or the system may automatically execute the tasks of the alternative solution. In some examples, the system may generate another prompt that indicates that the previously attempted technical solution was not successful (and, in some examples, any information that indicates why the technical solution was not successful), and the LLM may return another technical solution.

The system may store troubleshooting session data about the troubleshooting session. The troubleshooting session data may include technical issues (e.g., reported by users or detected by the television devices), the technical solutions, and/or the results of whether the implemented technical solutions and/or individual tasks of a respective technical solution were successful. The system may re-calibrate (e.g., update, fine-tune) the LLM with the troubleshooting session data.

In some examples, a media application, executable by a television device, renders a user interface that identifies a plurality of media content items that are available for streaming on the television device. In some examples, the media application is an operating system of the television device. In some examples, the media application is a native application installed on the operating system of the television device. A media content item may be a show, program, movie, etc. Selection of a media content item from the application's user interface causes the media content item to be streamed on the television device. For example, in response to selection of a media content item from the user interface, the media application may initiate playback of the media content item. In some examples, the user interface includes a section, tab, menu item, field, or a portion that enables the user to enter a natural language query to inquire about technical solutions to a particular technical issue. In some examples, the user may submit a natural language query by providing a voice command about a technical issue.

In some examples, in response to the information received via the interface (e.g., natural language query, image data, and/or video data), the media application may generate and transmit a prompt to an LLM that is trained to identify and provide one or more technical solutions to a technical issue. In some examples, the prompt includes the information received via the interface (e.g., the natural language query, the image, and/or the video) with a request to identify one or more technical solutions that solve the technical issue. In some examples, the media application may obtain device information about the television device and include the device information in the prompt. In some examples, the LLM may be stored on a server computer. In some examples, the LLM may be stored on the television device. In response to the prompt, the LLM may identify one or more technical solutions and generate a prompt response that includes the technical solution(s). In some examples, the LLM is a conventional large language model (e.g., based on a transformer architecture), adapted to generate text in response to an input (e.g., text, image, and/or video). In some examples, the LLM is calibrated with additional training data to identify troubleshooting solutions. In some examples, the LLM is trained on a large corpus of publicly available text, e.g., content from public databases and websites. In some examples, the LLM is further calibrated with television training data such as television user manuals, television source code and bug reports, television call center recordings, and/or online discussion forums.

The LLM generates and transmits a prompt response to the media application or the media platform. The prompt response includes the technical solution(s) identified by the LLM. The technical solution(s) may include text, image, and/or video that may solve the technical issue. In some examples, the media application may display the technical solution on the user interface. In some examples, the media application includes the task executor configured to execute the task(s) of the technical solution (without user involvement) to solve the technical issue. These and other features are further described with reference to the figures.

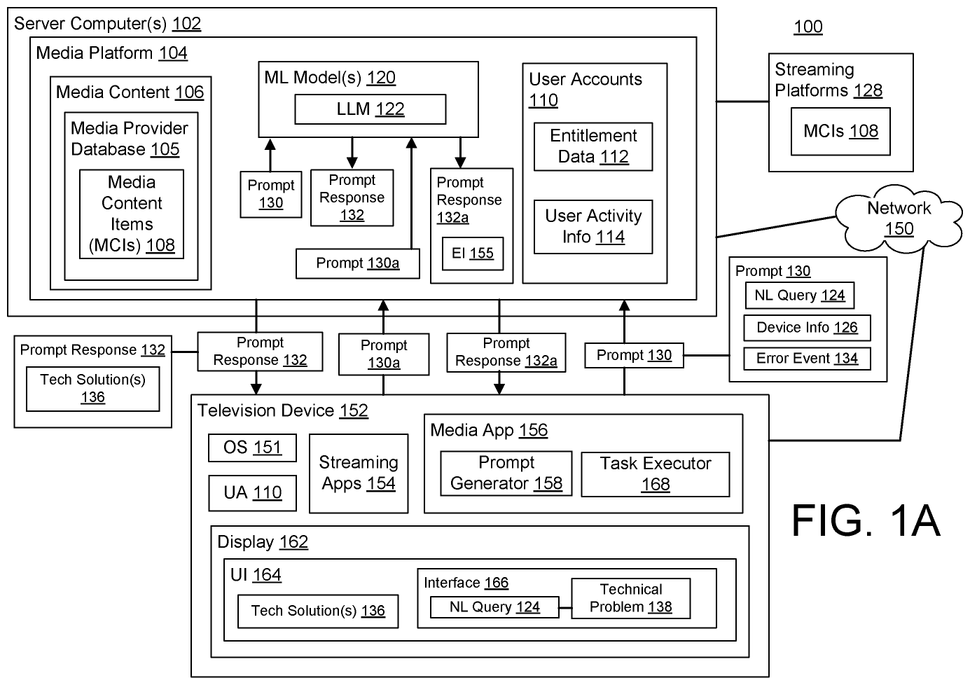

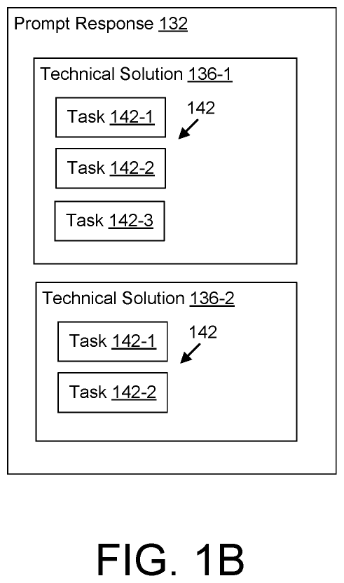

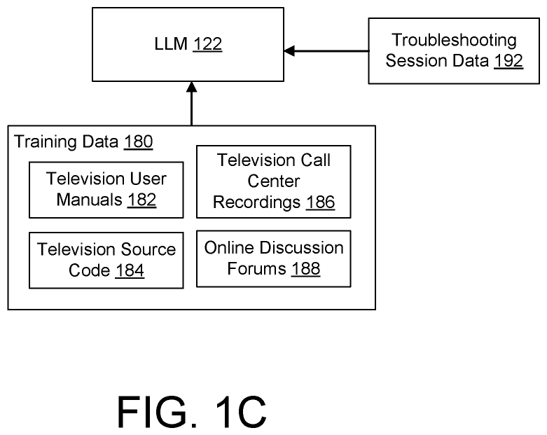

FIG. 1 illustrates a system 100 configured to calibrate (e.g., fine-tune, adjust) a ML model 120 (e.g., a LLM 122) (pre-trained large language model) (e.g., a text-to-text model) using training data 180 such as television user manuals 182, television source code 184 (including bug reports), television call center recordings 186, and/or online discussion forums 188. The system 100 provides a user interface 164 on a television device 152 that enables the user to submit information about a technical issue 138 of the television device 152. In some examples, the information includes a natural language query 124. In some examples, the information includes an image (e.g., a screenshot) of an interface of the television device, or multiple images. In some examples, the information includes one or more videos that depict the television device 152. In response to the information, the system 100 may generate a prompt 130 with a request for one or more technical solutions 136 to solve the technical issue 138 as described in the text, image, and/or video. In some examples, the system 100 may obtain device information 126 about the television device 152 (e.g., operating system version, make and model of television device, specification details about the television device, etc.), and include the device information 126 about the television device 152 in the prompt 130. The LLM 122 may determine which technical solutions 136 can be used to solve the technical issue(s) 138 and generate a prompt response 132 with information about the technical solution(s) 136. In some examples, the prompt response 132 includes text, image, or video that provides one or more tasks for solving the technical issue 138. In some examples, a technical solution 136 may include one or more tasks 142 (or a sequence of tasks 142), which, when performed, may solve the technical issue(s) 138.

The system 100 includes a media platform 104 executable by one or more server computers 102 and a media application 156 executable by a television device 152. The media platform 104 may be a server-based television platform. In some examples, the media application 156 is (or is a subcomponent of) an operating system 151 of the television device 152. In some examples, the media application 156 is a native application (e.g., a standalone native application), which is preinstalled on the television device 152 or downloaded to the television device 152 from a digital media store (e.g., play store, application store, etc.). The media application 156 may communicate with the media platform 104 to identify media content 106 that is available for streaming to the television device 152. The media content 106 includes a plurality of media content items 108. In some examples, the media content 106 includes media content items 108 that are stored on the media platform 104 and streamed from the media platform 104 to the media application 156. In some examples, the media content 106 includes media content items 108 that are stored on one or more (other) streaming platforms 128 and streamed from the streaming platforms 128 to their respective streaming applications 154.

In some examples, the media application 156 is a media aggregator application that determines which providers (e.g., streaming platforms 128, associated streaming applications 154) the user has access rights to, and then identifies media content items 108, across those providers, in the user interface 164 for selection and playback. For example, the media application 156 (e.g., in conjunction with the media platform 104) may aggregate (e.g., combine, assemble, collect, etc.) information about media content 106 available for viewing (e.g., streaming) from multiple streaming platforms 128 and present the information in the user interface 164 (e.g., a single, unified user interface) so that a user can identify and/or search media content 106 across different streaming platforms (e.g., without having to search within each streaming application 154). In some examples, the media content 106 is referred to as media content items 108 (e.g., individual programs offered by streaming platforms 128). For example, each media content item 108 may be a program (e.g., a television show, a movie, a live broadcast, etc.) from the media platform 104 or another streaming platform 128. Instead of searching for media content items 108 on a first streaming application and media content items 108 on a second streaming application, the media application 156 may combine the media content items 108 together in one interface (e.g., user interface 164) so that a user can search across multiple streaming platforms 128 at once.

In some examples, a media content item 108 may correspond to a digital video file, which may be stored on the streaming platforms 128 (including the media platform 104) and/or the television device 152. In some examples, the media platform 104 is also considered a streaming platform 128, which may store and provide digital video files for streaming or downloading. The digital video file may include video and/or audio data that corresponds to a particular media content item 108. In some examples, the media platform 104 is configured to communicate with the streaming platforms 128 to identify which media content 106 is available on the streaming platforms 128 and may update a media provider database 105 to identify the media content items 108 offered by the streaming platforms 128.

For example, the media platform 104 may communicate, over a network 150, with the streaming platforms 128 to identify which media content 106 is available to be streamed by television devices 152 and update a media provider database 105. The media platform 104 may identify a set or multiple sets of media content items 108 (e.g., across the various streaming platforms 128) as recommendations to a user of the media application 156. In some examples, the media platform 104 may determine whether the user of the media application 156 has rights (e.g., stored as entitlement data 112) to stream media content 106 from one or more of the streaming platforms 128 (e.g., whether the user has subscribed to access media content 106 from the streaming platform(s) 128), and, if so, may include those media content items 108 as candidates in a selection (e.g., ranking) mechanism to potentially be displayed in the user interface 164 of the media application 156.

The media application 156 includes a user interface 164 that identifies media content items 108 for selection and playback on the television device 152. In response to selection of a media content item 108, the media application 156 may initiate playback of the media content item 108 on a display 162 of the television device 152. In some examples, in response to selection of the media content item 108, the media platform 104 streams the media content item 108 to the media application 156, which causes the media application 156 to display the media content item 108 on the display 162. In some examples, in response to selection of the media content item 108 from the user interface 164 of the media application 156, the media application 156 causes the content's underlying streaming application 156 to playback the media content item 108.

In some examples, selection of a media content item 108 from the user interface 164 may cause the media application 156 to launch a streaming application 154 (e.g., using a content deep link) associated with the streaming application 154. In some examples, selection of a media content item 108 from the user interface 164 causes the media application 156 to render another user interface (e.g., item's landing page), and further selection of the media content item 108 from the item's landing page causes the media application 156 to launch the underlying streaming application 154. In some examples, the media content item 108 may be associated with a specific provider in which the media content item 108 is streamed from a streaming platform 128 (e.g., the media platform 104 itself or another streaming platform 128). In some examples, the user can control the playback of the media content item 108 from the corresponding streaming application 154.

A content deep link, corresponding to a media content item 108, may be an identifier that identifies the location of the media content item 108 in the streaming application 154. The media application 156 may transfer the content deep link to the corresponding streaming application 154. In some examples, the content deep link identifies a specific landing page (e.g., an interface) within the streaming application 154 that corresponds to the media content item 108. In some examples, the content deep link is an operating system intent. In some examples, the content deep link is a uniform resource locator (URL). In some examples, the content deep link includes a URL format.

Streaming (or playback) of the media content item 108 may refer to the transmission of the contents of a video file (e.g., media assets) from a streaming platform 128 or the media platform 104 to the television device 152 that displays the contents of the video file. In some examples, streaming (or playback) of the media content item 108 may refer to a continuous video stream that is transferred from one place to another place in which a received portion of the video stream is displayed while waiting for other portions of the video stream to be transferred. In some examples, after the media content item 108 is published on the media platform 104 (e.g., is live), the television device 152 may stream or download the contents of the video file.

In some examples, the user interface 164 may identify a plurality of media content items 108, which may be selected by the media platform 104 from the media provider database 105 based at least in part on information representing the user's interests and activities (e.g., the user's search queries, search results, previous watch history, purchase history, application usage history, application installation history, user actions on the network-connected display device, physical activities of the user, etc.). In some examples, the media application 156 may be associated with a user account 110, and the user account 110 may store the information representing the user's interests and activities (e.g., user activity information 114), and the media platform 104 may use this information to select and present the media content items 108 in the user interface 164. In some examples, the media content items 108 may be organized as a plurality of clusters based on one or more categories, such as content type (e.g., “Action Movies”), viewing history (e.g., “Because You watched Movie ABC”), release time (e.g., “Trending”), and the like. In some examples, the media content items 108 provided by different streaming platforms 128 (e.g., action movies from two different streaming platforms 128) can be recommended in the same cluster. In some examples, the user interface 164 may include tabbed interfaces, where one of the tabbed interfaces includes personalized media content that is organized as a plurality of clusters based on one or more categories, such as release time (e.g., “This Week,” “Next week,” “Next Month,” etc.), user action and user application interaction, native app usage (e.g., items that are “From App ABC”), etc.

It is noted that a user of the media application 156 may be provided with controls allowing the user to make an election as to both if and when the system 100 may enable the collection of information representing the user's interests and activities. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user of the media application 156 may have control over what information is collected about the user, how that information is used, and what information is provided to the user and/or to the server computer 102.

In some examples, the media application 156 displays an interface 166 for receiving information about a technical issue 138. In some examples, the information includes a natural language query 124. In some examples, the information includes one or more images about the technical issue 138. In some examples, the information includes one or more video files about the technical issue 138.

A technical issue 138 may be any issue or task relating to an operation of a television device 152. A technical issue 138 may be referred to as a problem (or technical problem) or an issue (or performance issue). A technical issue 138 may encompass a wide range of issues, including but not limited to issues with picture quality, sound, performance, software configuration, hardware configuration, connectivity, or a functionality of the television device 152. Troubleshooting involves a systematic process of identifying and resolving technical problems to restore the device's optimal performance. A technical issue 138 may be any type of problem or a task relating to the functioning of a television device 152. In some examples, a technical issue 138 may encompass a wide range of issues, such as picture quality issues, sound issues, connectivity issues, functional issues, application issues, operating system issues, hardware issues, and/or power issues. For example, the user may enter “the sound on the television device does not work.” In some examples, the interface 166 includes an input field that enables the user to submit information about the technical issue 138, including a natural language query 124, image(s), and/or video(s). For example, a user may transfer, upload, or download images and/or videos to the television device 152. In some examples, a user may enter text into the input field to define the natural language query 124. In some examples, the interface 166 may be a user interface configured to receive text via a voice command and may display the text of the voice command in the input field. In some examples, the interface 166 may receive image data such as a screenshot of the device's interface, or video data that includes a sequence of images involving the television device 152.

The media application 156 includes a prompt generator 158 configured to generate a prompt 130 to be used as an input to the ML model 120. In response to receipt of information provided by the user via the interface 116, which may include the natural language query 124, image data, and/or video data, the prompt generator 158 may generate the prompt 130. The prompt 130 may be a request to identify one or more technical solutions 136 by the ML model 120 using the information identified via the interface 166, which may include the natural language query 124, image data, and/or video data. In some examples, the prompt generator 158 may obtain device information 126 about the television device 152 and include the device information 126 in the prompt 130. In some examples, the media application 156 detects an error event 134 that is generated internally by the television device 152. The error event 134 may be generated by the operating system 151 and may include information about the error. In some examples, in response to the error event 134, the prompt generator 158 generates the prompt 130 with the information about the error event 134 and the device information 126.

The media platform 104 may receive the prompt 130 and provide the prompt 130 to the ML model 120 (or the media application 156 provides the prompt 130 directly to the ML model 120). The media application 156 transmits the prompt 130 to a ML model 120. In some examples, the ML model 120 is stored on the server computer(s) 102, which also executes the media platform 104. In some examples, the ML model 120 is stored on one or more server computers that are different from the server computer(s) 102 that execute the media platform 104. In some examples, the media platform 104 receives the prompt 130 and then transmits the prompt 130 to the ML model 120. In some examples, the ML model 120 is stored (e.g., stored locally) on the television device 152. In some examples, the ML model 120 is included as part of the operating system 151. In response to the prompt 130, the ML model 120 may identify one or more technical solutions 136 to address the technical issue 138. A technical solution 136 may include one or more tasks 142. The ML model 120 may generate a prompt response 132 that includes the technical solution(s). As shown in FIG. 1B, the technical solutions 136 may include a technical solution 136-1 executable by a task 142-1, a task 142-2, and a task 142-3, and a technical solution 136-2 executable by a task 142-1 and a task 142-2.

In some examples, the ML model 120 includes a large language model (LLM) 122. In some examples, the LLM 122 is a conventional large language model (e.g., based on a transformer architecture), adapted to generate data, which may include text, audio, image, and/or video, in response to an input, which may include text, video, image, and/or audio. Such LLMs are trained on a large corpus of publicly available text, e.g., content from public databases and websites.

The LLM 122 may include any type of pre-trained large language model (LLM) configured to identify technical solutions 136 in response to a prompt 130. The LLM 122 includes weights, where the weights are numerical parameters that the LLM 122 learns during the training process. The weights are used to compute the output (e.g., the prompt response 132) of the LLM 122. In some examples, the LLM 122 includes a pre-trained language model that has been fine-tuned with additional training data (e.g., training data 180) to identify technical solutions 136. In some examples, the LLM 122 is a mixed-modality AI model that can receive audio, video, image, and/or text, and identify (or generative) audio, video, image, and/or text.

The LLM 122 may receive one or more inputs, where the input(s) includes information in the prompt 130. In some examples, the LLM 122 may include a pre-processing engine configured to pre-process the text input. Pre-processing may include converting the text input to individual tokens (e.g., words, phrases, or characters). Pre-processing may include other operations such as removing stop words (e.g., “the”, “and”, “of”) or other terms or syntax that do not impart any meaning to the LLM 122. The LLM 122 includes an embedding engine configured to generate embeddings from the pre-processed text input. In some examples, the embedding engine may receive image, audio, or video data and generate embeddings that represent the underlying information. The embeddings may be vector representations that assist the LLM 122 to capture the semantic meaning of the input tokens and may assist the LLM 122 to better understand the relationships between the input tokens. The LLM 122 includes a neural network(s) configured to receive the embeddings and generate an output.

A neural network includes multiple layers of interconnected neurons (e.g., nodes). The neural network may include an input layer, one or more hidden layers, and an output later. The output may include a sequence of output word probability distributions, where each output distribution represents the probability of the next word in the sequence given the input sequence so far. In some examples, the output may be represented as a probability distribution over the vocabulary or a subset of the vocabulary. The neural network(s) is configured to receive the embeddings and generate an output, and, in some examples, the query activity (e.g., previous natural language queries 124 and prompt responses 132). The output may include text, audio, video, and/or image data. In some examples, the output may include a sequence of output word probability distributions, where each output distribution represents the probability of the next word in the sequence given the input sequence so far. In some examples, the output may be represented as a probability distribution over the vocabulary or a subset of the vocabulary. The decoder is configured to receive the output and generate the technical solution(s) 136. In some examples, the decoder may select the most likely instruction, sampling from a probability distribution, or using other techniques to generate coherent and valid source code. The LLM 122 includes a decoder configured to receive the output and generate a prompt response 132 with the technical solution(s) 136.

The ML model 120 generates and transmits a prompt response 132 with the technical solution 136. In response to receiving the prompt response 132, the media application 156 may display the technical solution(s) 136 on the user interface 164. In some examples, the user may use the television device 152 to execute the task(s) 142 of a particular technical solution 136 to solve the technical issue 138.

In some examples, the television device 152 includes a task executor 168 configured to execute the task(s) 142 of the technical solution 136 (without user involvement) to solve the technical issue 138. For example, instead of the user performing the tasks 142 using the television device 152, the television device 152 itself programmatically performs the technical solution 136 by executing the task(s) 142. In some examples, the task executor 168 may transmit a code request (e.g., a prompt 130a) to the LLM 122 to obtain executable instructions 155. The LLM 122 may generate a prompt response 132a with executable instructions 155, and the media platform 104 may provide the executable instructions 155 to the television device 152. The executable instructions 155, when executed by the television device 152, cause the television device 152 to execute the tasks 142 of the technical solution 136. In some examples, the user interface 164 of the media application 156 includes one or more UI elements that enable the user an option for the user to perform the task(s) 142 or the television device 152 to perform the task(s) 142. In some examples, instead of submitting a natural language query 124 about a technical issue 138, the television device 152 may programmatically detect a technical issue (e.g., detect an error event 134), communicate with the LLM 122 to identify a technical solution 136, and initiate the task executor 168 to programmatically execute the tasks 142 of the technical solution 136 without involvement of the user.

In some examples, the media application 156 may determine whether or not the technical solution 136 was successful in solving the technical issue 138. In some examples, the user may provide feedback via the user interface 164 that indicates whether or not the technical solution 136 was successful in solving the technical issue 138. In some examples, the media application 156 may programmatically determine (without user prompting) whether the technical solution 136 was successful. If the technical solution 136 was not successful, the media application 154 may identify another technical solution 136 (e.g., from the prompt response 132), and display the alternative technical solution 136 on the user interface 164 or the media application 156 may automatically execute the tasks 142 of the alternative technical solution 136. In some examples, the prompt generator 158 may generate another prompt that indicates that the previously attempted technical solution 136 was not successful (and, in some examples, any information that indicates why the technical solution was not successful), and the LLM 122 may return another technical solution 136.

The system may store troubleshooting session data 192 about the troubleshooting session. The troubleshooting session data 192 may include technical issues 138 (e.g., reported by users or detected by the television devices 152), the technical solutions 136, and/or the results of whether the implemented technical solutions 136 and/or individual tasks 142 of a respective technical solution 136 were successful. The system 100 may re-calibrate (e.g., update, fine-tune) the LLM 122 with the troubleshooting session data 192.

The media platform 104 may store user accounts 110, where each user account 110 stores information about a respective user. A user account 110 may store entitlement data 112 and/or user activity information 114. The entitlement data 112 includes information that identifies which providers (e.g., streaming platforms 128, streaming applications 154) that the user account 110 has access rights to view content. In some examples, the access rights are determined based on the user account 110 (e.g., whether the user has subscribed to one or more streaming applications 154), which streaming applications 154 are installed on the television device 152 and/or if the user has accessed (e.g., logged-into) a user account associated with those streaming applications 154. In response to certain user activity regarding media content items 108, the media platform 104 may update the user activity information 114 with information about the activity such as a content identifier 135, the date/time, and/or the watch duration of the media content item 108, etc.

The television device 152 includes one or more processors, one or more memory devices, and an operating system 151 configured to execute (or assist with executing) one or more streaming applications 154. The one or more memory devices may be a non-transitory computer-readable medium storing executable instructions that cause the one or more processors to execute operations discussed herein. The television device 152 may be any type of television (e.g., a smart television). The streaming applications 154 may include a media application 156 configured to communicate, over the network, 150, with a media platform 104 executable by one or more server computers 102. In some examples, the media application 156 is a program that is part of the operating system 151. In some examples, the media application 156 is a separate standalone application that is downloaded and installed on the operating system 151. In some examples, the media application 156 may execute operation(s) discussed with reference to the operating system 151 (and/or vice versa). In some examples, the television device 152 is not a smart television, but is converted to a smart television when connected to a casting device, where the casting device is configured to connect to the network 150 and execute an operating system 151 configured to execute streaming applications 154, including the media application 156.

In some examples, the operating system 151 is a browser application. A browser application is a web browser configured to access information on the Internet and may launch one or more browser tabs in the context of one or more browser windows. In some examples, the operating system 151 is a Linux-based operating system. In some examples, the operating system 151 is a mobile operating system that is also configured to execute on smaller devices (e.g., smartphones, tablets, wearables, etc.).

The server computer 102 may be computing devices that take the form of a number of different devices, for example a standard server, a group of such servers, or a rack server system. In some examples, the server computer 102 may be a single system sharing components such as processors and memories. The network 150 may include the Internet and/or other types of data networks, such as a local area network (LAN), a wide area network (WAN), a cellular network, satellite network, or other types of data networks. The network 150 may also include any number of computing devices (e.g., computer, servers, routers, network switches, etc.) that are configured to receive and/or transmit data within network 150. Network 150 may further include any number of hardwired and/or wireless connections.

The server computer 102 may include one or more processors formed in a substrate, an operating system (not shown) and one or more memory devices. The memory devices may represent any kind of (or multiple kinds of) memory (e.g., RAM, flash, cache, disk, tape, etc.). In some examples (not shown), the memory devices may include external storage, e.g., memory physically remote from but accessible by the server computer 102. The server computer 102 may include one or more modules or engines representing specially programmed software.

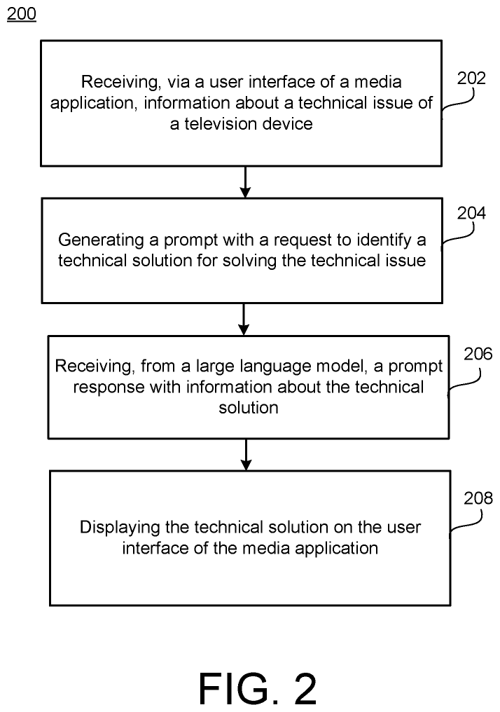

FIG. 2 is a flowchart 200 depicting example operations of identifying and/or implementing technical solutions for a technical issue of a television device. The flowchart 200 may depict operations of a computer-implemented method. The flowchart 200 may depict operations of a non-transitory computer-readable medium having executable instructions that when executed by one or more processors cause the one or more processors to execute the operations of the flowchart 200. Although the flowchart 200 is explained with respect to the system 100 of FIGS. 1A to 1C, the flowchart 200 may be applicable to any of the implementations discussed herein. Although the flowchart 200 of FIG. 2 illustrates the operations in sequential order, it will be appreciated that this is merely an example, and that additional or alternative operations may be included. Further, operations of FIG. 2 and related operations may be executed in a different order than that shown, or in a parallel or overlapping fashion.

Operation 202 includes receiving, via a user interface of a media application, information about a technical issue of a television device. Operation 204 includes generating a prompt with a request to identify a technical solution for solving the technical issue. Operation 206 includes receiving, from a large language model, a prompt response with information about the technical solution. Operation 208 includes displaying the technical solution on the user interface of the media application.

Clause 1. A method comprising: receiving, via a user interface of a media application, information about a technical issue of a television device; generating a prompt with a request to identify a technical solution for solving the technical issue; receiving, from a large language model, a prompt response with information about the technical solution, the large language model being calibrated based on at least one of television user manuals, television call center recording, television source code, or online discussion forums; and displaying the technical solution on the user interface of the media application.

Clause 2. The method of clause 1, wherein the information about the technical issue includes a natural language query.

Clause 3. The method of clause 1, wherein the information about the technical issue includes an image of at least a portion of an interface of the television device or a video that includes at least a portion of the television device.

Clause 4. The method of clause 1, further comprising: obtaining device information about the television device, wherein the prompt also includes the device information.

Clause 5. The method of clause 1, further comprising: programmatically performing the technical solution by executing one or more tasks without user interaction.

Clause 6. The method of clause 1, further comprising: transmitting a secondary prompt with a request to generate source code for performing the technical solution; receiving a secondary prompt response with the source code; and executing the source code to perform the technical solution.

Clause 7. The method of clause 1, further comprising: generating troubleshooting session data, the troubleshooting session data including the technical issue, the technical solution, and whether the technical solution was successful to solve the technical issue; and re-calibrating the large language model with the troubleshooting session data.

Clause 8. The method of clause 1, further comprising: providing a user interface (UI) element on the user interface, wherein selection of the UI element causes the television device to perform the technical solution.

Clause 9. The method of clause 1, wherein the technical issue is a first technical issue, the prompt is a first prompt, the technical solution is a first technical solution, and the prompt response is a first prompt response, the method further comprising: detecting an error event about a second technical issue on the television device; in response to detection of the error event, generating, without user interaction, a second prompt with a request to identify a second technical solution for solving the second technical issue; receiving, from the large language model, a second prompt response with information about the second technical solution; and displaying the second technical solution on the user interface of the media application.

Clause 10. A television device comprising: at least one processor; and a non-transitory computer-readable medium storing executable instructions that cause the at least one processor to: receive, via a user interface of a media application, a natural language query about a technical issue of a television device; generate a prompt with a request to identify a technical solution for solving the technical issue; receive, from a large language model, a prompt response with information about the technical solution, the large language model being calibrated based on at least one of television user manuals, television call center recording, television source code, or online discussion forums; and display the technical solution on the user interface of the media application.

Clause 11. The television device of clause 10, wherein the executable instructions include instructions that cause the at least one processor to: transmit a secondary prompt with a request to generate source code for performing the technical solution; receive a secondary prompt response with the source code; and execute the source code to perform the technical solution.

Clause 12. The television device of clause 10, wherein the executable instructions include instructions that cause the at least one processor to: generate troubleshooting session data, the troubleshooting session data including the technical issue, the technical solution, and whether the technical solution was successful to solve the technical issue; and re-calibrate the large language model with the troubleshooting session data.

Clause 13. The television device of clause 10, wherein the executable instructions include instructions that cause the at least one processor to: provide a user interface (UI) element on the user interface, wherein selection of the UI element causes the television device to perform the technical solution.

Clause 14. The television device of clause 10, wherein the technical issue is a first technical issue, the prompt is a first prompt, the technical solution is a first technical solution, and the prompt response is a first prompt response, wherein the executable instructions include instructions that cause the at least one processor to: detect an error event about a second technical issue on the television device; in response to detection of the error event, generate, without user interaction, a second prompt with a request to identify a second technical solution for solving the second technical issue; receive, from the large language model, a second prompt response with information about the second technical solution; and display the second technical solution on the user interface of the media application.

Clause 15. A non-transitory computer-readable medium storing executable instructions that when executed by at least one processor cause the at least one processor to execute operations, the operations comprising: receiving, via a user interface of a media application, information about a technical issue of a television device; generating a prompt with a request to identify a technical solution for solving the technical issue; receiving, from a large language model, a prompt response with information about the technical solution, the large language model being calibrated based on at least one of television user manuals, television call center recording, television source code, or online discussion forums; and displaying the technical solution on the user interface of the media application.

Clause 16. The non-transitory computer-readable medium of clause 15, wherein the operations further comprise: obtaining device information about the television device, wherein the prompt also includes the device information.

Clause 17. The non-transitory computer-readable medium of clause 15, wherein the operations further comprise: programmatically performing the technical solution by executing one or more tasks without user interaction.

Clause 18. The non-transitory computer-readable medium of clause 15, wherein the operations further comprise: transmitting a secondary prompt with a request to generate source code for performing the technical solution; receiving a secondary prompt response with the source code; and executing the source code to perform the technical solution.

Clause 19. The non-transitory computer-readable medium of clause 15, wherein the operations further comprise: generating troubleshooting session data, the troubleshooting session data including the technical issue, the technical solution, and whether the technical solution was successful to solve the technical issue; and re-calibrating the large language model with the troubleshooting session data.

Clause 20. The non-transitory computer-readable medium of clause 15, wherein the technical issue is a first technical issue, the prompt is a first prompt, the technical solution is a first technical solution, and the prompt response is a first prompt response, the operations further comprising: detecting an error event about a second technical issue on the television device; in response to detection of the error event, generating, without user interaction, a second prompt with a request to identify a second technical solution for solving the second technical issue; receiving, from the large language model, a second prompt response with information about the second technical solution; and displaying the second technical solution on the user interface of the media application.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are remote from each other and typically interact through a communication network. The relationship of client and server arises by virtue of computer programs running on the respective computers and having a client-server relationship with each other.

In this specification and the appended claims, the singular forms “a,” “an” and “the” do not exclude the plural reference unless the context clearly dictates otherwise. Further, conjunctions such as “and,” “or,” and “and/or” are inclusive unless the context clearly dictates otherwise. For example, “A and/or B” includes A alone, B alone, and A with B. Further, connecting lines or connectors shown in the various figures presented are intended to represent example functional relationships and/or physical or logical couplings between the various elements. Many alternative or additional functional relationships, physical connections or logical connections may be present in a practical device. Moreover, no item or component is essential to the practice of the implementations disclosed herein unless the element is specifically described as “essential” or “critical”.

Terms such as, but not limited to, approximately, substantially, generally, etc. are used herein to indicate that a precise value or range thereof is not required and need not be specified. As used herein, the terms discussed above will have ready and instant meaning to one of ordinary skill in the art.

Moreover, use of terms such as up, down, top, bottom, side, end, front, back, etc. herein are used with reference to a currently considered or illustrated orientation. If they are considered with respect to another orientation, it should be understood that such terms must be correspondingly modified.

Although certain example methods, apparatuses and articles of manufacture have been described herein, the scope of coverage of this patent is not limited thereto. It is to be understood that terminology employed herein is for the purpose of describing particular aspects and is not intended to be limiting. On the contrary, this patent covers all methods, apparatus and articles of manufacture fairly falling within the scope of the claims of this patent.

What is claimed is:

1. A method comprising:
receiving, via a user interface of a media application, information about a technical issue of a television device;
generating a prompt with a request to identify a technical solution for solving the technical issue;
receiving, from a large language model, a prompt response with information about the technical solution, the large language model being calibrated based on at least one of television user manuals, television call center recording, television source code, or online discussion forums; and
displaying the technical solution on the user interface of the media application.

2. The method of claim 1, wherein the information about the technical issue includes a natural language query.

3. The method of claim 1, wherein the information about the technical issue includes an image of at least a portion of an interface of the television device or a video that includes at least a portion of the television device.

4. The method of claim 1, further comprising:
obtaining device information about the television device, wherein the prompt also includes the device information.

5. The method of claim 1, further comprising:
programmatically performing the technical solution by executing one or more tasks without user interaction.

6. The method of claim 1, further comprising:
transmitting a secondary prompt with a request to generate source code for performing the technical solution;
receiving a secondary prompt response with the source code; and
executing the source code to perform the technical solution.

7. The method of claim 1, further comprising:
generating troubleshooting session data, the troubleshooting session data including the technical issue, the technical solution, and whether the technical solution was successful to solve the technical issue; and
re-calibrating the large language model with the troubleshooting session data.

8. The method of claim 1, further comprising:
providing a user interface (UI) element on the user interface, wherein selection of the UI element causes the television device to perform the technical solution.

9. The method of claim 1, wherein the technical issue is a first technical issue, the prompt is a first prompt, the technical solution is a first technical solution, and the prompt response is a first prompt response, the method further comprising:
detecting an error event about a second technical issue on the television device;
in response to detection of the error event, generating, without user interaction, a second prompt with a request to identify a second technical solution for solving the second technical issue;
receiving, from the large language model, a second prompt response with information about the second technical solution; and
displaying the second technical solution on the user interface of the media application.

10. A television device comprising:
at least one processor; and
a non-transitory computer-readable medium storing executable instructions that cause the at least one processor to:
receive, via a user interface of a media application, a natural language query about a technical issue of a television device;
generate a prompt with a request to identify a technical solution for solving the technical issue;
receive, from a large language model, a prompt response with information about the technical solution, the large language model being calibrated based on at least one of television user manuals, television call center recording, television source code, or online discussion forums; and
display the technical solution on the user interface of the media application.

11. The television device of claim 10, wherein the executable instructions include instructions that cause the at least one processor to:
transmit a secondary prompt with a request to generate source code for performing the technical solution;
receive a secondary prompt response with the source code; and
execute the source code to perform the technical solution.

12. The television device of claim 10, wherein the executable instructions include instructions that cause the at least one processor to:
generate troubleshooting session data, the troubleshooting session data including the technical issue, the technical solution, and whether the technical solution was successful to solve the technical issue; and
re-calibrate the large language model with the troubleshooting session data.

13. The television device of claim 10, wherein the executable instructions include instructions that cause the at least one processor to:
provide a user interface (UI) element on the user interface, wherein selection of the UI element causes the television device to perform the technical solution.

14. The television device of claim 10, wherein the technical issue is a first technical issue, the prompt is a first prompt, the technical solution is a first technical solution, and the prompt response is a first prompt response, wherein the executable instructions include instructions that cause the at least one processor to:
detect an error event about a second technical issue on the television device;
in response to detection of the error event, generate, without user interaction, a second prompt with a request to identify a second technical solution for solving the second technical issue;
receive, from the large language model, a second prompt response with information about the second technical solution; and
display the second technical solution on the user interface of the media application.

15. A non-transitory computer-readable medium storing executable instructions that when executed by at least one processor cause the at least one processor to execute operations, the operations comprising:
receiving, via a user interface of a media application, information about a technical issue of a television device;
generating a prompt with a request to identify a technical solution for solving the technical issue;
receiving, from a large language model, a prompt response with information about the technical solution, the large language model being calibrated based on at least one of television user manuals, television call center recording, television source code, or online discussion forums; and
displaying the technical solution on the user interface of the media application.

16. The non-transitory computer-readable medium of claim 15, wherein the operations further comprise:
obtaining device information about the television device, wherein the prompt also includes the device information.

17. The non-transitory computer-readable medium of claim 15, wherein the operations further comprise:
programmatically performing the technical solution by executing one or more tasks without user interaction.

18. The non-transitory computer-readable medium of claim 15, wherein the operations further comprise:
transmitting a secondary prompt with a request to generate source code for performing the technical solution;
receiving a secondary prompt response with the source code; and
executing the source code to perform the technical solution.

19. The non-transitory computer-readable medium of claim 15, wherein the operations further comprise:
generating troubleshooting session data, the troubleshooting session data including the technical issue, the technical solution, and whether the technical solution was successful to solve the technical issue; and
re-calibrating the large language model with the troubleshooting session data.

20. The non-transitory computer-readable medium of claim 15, wherein the technical issue is a first technical issue, the prompt is a first prompt, the technical solution is a first technical solution, and the prompt response is a first prompt response, the operations further comprising:
detecting an error event about a second technical issue on the television device;
in response to detection of the error event, generating, without user interaction, a second prompt with a request to identify a second technical solution for solving the second technical issue;
receiving, from the large language model, a second prompt response with information about the second technical solution; and
displaying the second technical solution on the user interface of the media application.
